(19) United States
(12) Patent Application Publication
(10) Pub. No.: US 2020/0349555 A1
(43) Pub. Date: Nov. 5, 2020

(54) KNOWLEDGE CURRENCY UNITS

(71) Applicant: ZOE LIFE TECHNOLOGIES HOLDING AG, Herisau (CH)

(72) Inventor: Hardy Schloer, München (DE)

(21) Appl. No.: 16/929,771

(22) Filed: Jul. 15, 2020

Related U.S. Application Data
(63) Continuation of application No. PCT/EP2019/051082, filed on Jan. 16, 2019.

(30) Foreign Application Priority Data
Jan. 16, 2018 (DE) 10 2018 100 895.3

(51) Int. Cl. G06Q 20/36; G06Q 30/00; G06F 16/48; H04L 29/12

(52) U.S. Cl. CPC G06Q 20/3672; G06Q 20/3678; G06Q 2220/00; G06F 16/48; H04L 61/35; G06Q 30/0185

(57) ABSTRACT

A computer-implemented method is provided for creating currency units, comprising the following steps: identifying knowledge, associating a computer-processable object with the knowledge, and connecting a unique IPv6 number with the object. A computer-processable object is provided, comprising: data representing knowledge, a currency unit representative of credibility of the knowledge and/or of application scope of the knowledge, and an IPv6 number, the IPv6 number being unique for the object. A currency unit is provided, comprising a count being representative of credibility of knowledge and/or of application scope of knowledge, an object being associated with the currency unit, and an IPv6 number, the IPv6 number being unique for the object.

### CROSS REFERENCE TO RELATED APPLICATIONS

This application is a continuation of International Application No. PCT/EP2019/051082, filed on Jan. 16, 2019, which takes priority from German Patent Application No. 10 2018 100 895.3, filed on Jan. 16, 2018, the contents of each of which are incorporated by reference herein.

### TECHNICAL FIELD

The present invention relates to creating currency units.

### BACKGROUND

Over the past few years, there has been significantly increasing discussion in finance, technology and public administration circles that the ‘new’ global currency will become information.

The amount of data together with the processing speed to analyse this data and take action, has moved beyond the cognitive reaction abilities of humans. Generally, there are 2 megatrends, which force the entire world of business and trade into electronic currencies. First of all, the competition is driven by Artificial Intelligence programs, which take advantage of big data to implement within milliseconds complex trades across borders and competition lines. Secondly, the business model of FIAT currencies is about to end, as transparency of information systems expose the true problems with these financial instruments. Beyond this, the business model of B2C and B2B is about to disappear and be replaced by C2M and B2M trades. Therefore, the true value of the future is data and knowledge, which enables fast and profitable trade strategies ahead of the competition.

This deluge of data is growing fast. The total amount of data in the world was 4.4 zettabytes in 2013. That is set to rise steeply to 44 zettabytes by 2020. To put that in perspective, one zettabyte is equivalent to 44 trillion gigabytes. This sharp rise in data will be driven by rapidly growing daily production of data. But how much data is produced everyday today?

This truth in this discussion only becomes more obvious and logical with the passing of time. Since the term “big data” was fashioned explain what any large volume of data possesses when interconnected and the immense value in aggregating knowledge that could come from its possession began to become realized, ‘knowledge currency’ has gained continued momentum.

Enter {Data Currency Units} (DCU) and the reality of the world's first cryptocurrency backed by knowledge-data. Not just data, but ‘knowledge data’—a distinct value differentiator in the context of ‘data’ definitions.

### SUMMARY

A computer-implemented method of creating currency units is provided, comprising the following steps: identifying knowledge, associating a computer-processable object with the knowledge, and connecting a unique IPv6 number with the object.

A computer-processable object, comprising: data representing knowledge, a currency unit representative of credibility of the knowledge and/or of application scope of the knowledge, and an IPv6 number, the IPv6 number being unique for the object.

A currency unit, comprising a count being representative of credibility of knowledge and/or of application scope of knowledge, an object being associated with the currency unit, and an IPv6 number, the IPv6 number being unique for the object.

There are many emerging so called cryptocurrencies in use today. The most traded one is Bitcoin, which perceived trading value rose from only a dollar to near 40,000 in a short time. The problem is, that many cryptocurrencies are based on something (products or services) which may no longer exist in the future.

We solved the problem to tie forever, through our fully generalized and standardized Knowledge-Creation system the identifiable and traceable object of money to specific objects of value (in our case valid and usable knowledge). By connecting Objects of Money, a traceable Unit with a IPv6 number to an object of real value, we solve 2 problems. First, the value of money is not deflating, but steadily and none-volatile increasing, as the system is creating continuously new knowledge, and secondly, the taxation of transactions can be extremely easy, as the flow of money is exquisitely preserved and transparent. This makes this the first crypto currency which actually combats money laundering and tax evasion. The relationship between Money, IPv6 and objects of value is unique.

FIG. 1 illustrates how much data is produced every day.

2.5 Exabytes of data are produced per day. This is equivalent to:
530,000,000 millions songs;
150,000,000 iPhones;
5 million laptops;
250,000 Libraries of Congress;
90 years of HD video.

The technical model:

We have created an underlying technical asset model based on “banked” Knowledge Objects (KO) in our Quantum Relations Machine central database (QRMD)—actual assets that we possess). This is in form of data objects which have been created through analysis, and which can be 100% verified (even from external authorized sources) because each knowledge object has a unique and traceable IPv6 number with a fixed resolution between 0.1 and 5.0, providing each KO a quantifiable asset footprint, based on the qualitative and quantitative nature of each knowledge object. We can reserve on each KO a specific COM port to connect to the QRMD asset server, a computer, which is at a neutral place and where its asset holdings/audit results are monitored by a major accounting firm in order to validate the total asset holdings at any given time.

Usually, knowledge objects become less useful over time, or become gradually outdated or replaced by new and expanding knowledge objects in the Knowledge Object pool. All this is verifiable in real-time because the QRMD KOs report themselves every hour {periodicity} to the independent asset server. Each KO is set with a total count, a resolution for example, a number (0.1 to 5.0) and a validity reading of up to 100 (maximum usability) and to as low as 0.1 (almost no application scope).

An Example of the value formula:

100 units of information/knowledge=1 unit of money

The total quantitative result of knowledge, using this formula, is the total underlying asset of the {Data Currency Unit} (DCU).

Generally, we know that the asset pool is continuously and much more rapidly expanding with new KOs, than shrinking from outdated KOs (remember that quantifiable expansion of asset objects, automatically results into the issue of new cryptocurrency). Therefore, to fully guarantee a continuously rising/expanding asset base, we create and verify the rule that 75% of the sales income of the {DCU} are re-invested in new knowledge creation by funding the continuous acquisition of data and hardware to analyze it with our superior and proprietary AI model.

This has a result that our {DCU} coin would not only expand in issued volume, but also substantially in value. An independent asset management firm could then act like a central bank by controlling the released money supply in the open market to stabilize volatility and just assure a steady but reasonable rise in the {DCU} coin currency value. The price of the {DCU} coin could be either fixed or market based.

Currently, new crypto currencies are entering the market everywhere, raising billions of $ USD and all lacking the transparency and asset coupling that the DCU offers.

This {DCU} model offers all that the existing cryptocurrency models do not; humanity's greatest asset attachment (knowledge—an asset that has greater value than gold and other traditional physical stores of value) and real-time, publishable accountability (total transparency). This digital currency has REAL value—the one thing that is creating, and will continue to create volatility in every other cryptocurrency presently in the global marketplace.

The {DCU} platform has already been developed and it is growing its Knowledge Object pool every minute of every day, meaning its coin value is already rising continuously. The entire cryptocurrency is fully beta-implementable within 30 days.

What the DCU represents is merely the first organization/project to successfully create an information currency. By doing so, the premium becomes knowledge, not wealth, which means that the market behavior is changing in accordance.

### BRIEF DESCRIPTION OF THE DRAWINGS

The invention and the features of the claims are further described in connection with the Figures and the code examples.

FIG. 1 illustrates how much data is produced every day.

FIG. 2 illustrates the identification and extraction of knowledge, the assignment of an IPv6 number to an object, and the creation of knowledge objects.

### DETAILED DESCRIPTION

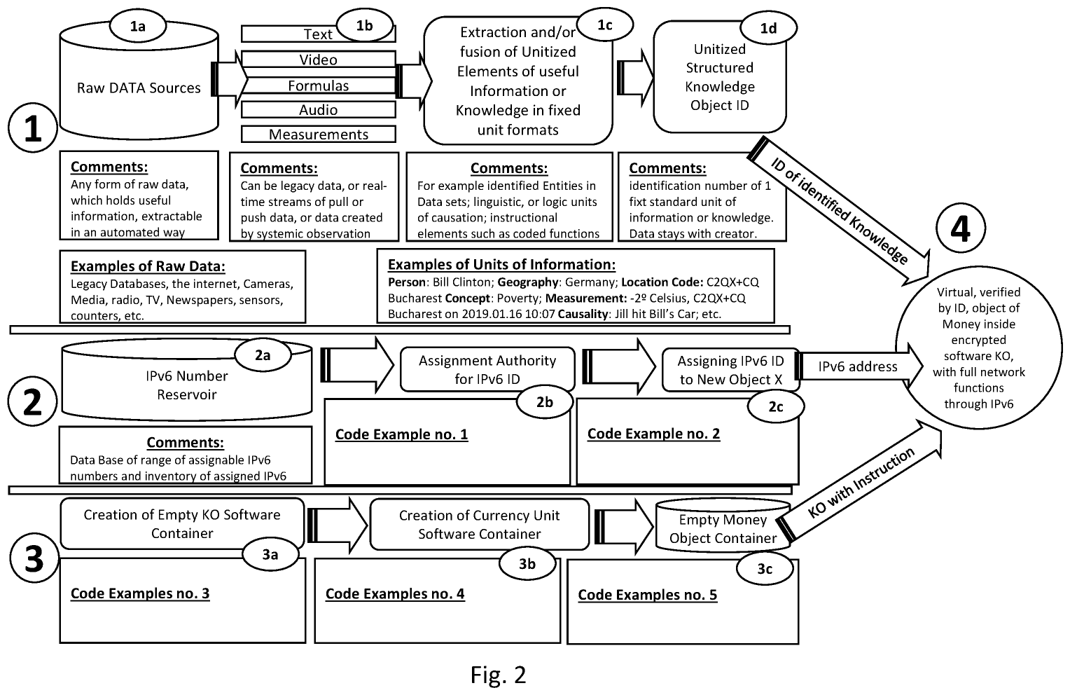

Identifying/extracting knowledge (1a, 1b and 1c elements in FIG. 2).

Knowledge comes in various forms and can be carried in any media.

Identifying and extracting knowledge methods vary depending on the format and media that is carrying it. So, we are using different algorithms and tools as follows:
1) Text->text carry/describe knowledge with the help of natural language. So, in order to process it there are used methods and algorithms in the Natural Language Processing fields. With the help of those algorithms we extract: entities (persons, organizations, physical objects), locations, properties of the extracted entities (for example: a scientific article can contain lots of newly discovered properties of a metal), causations (triples that describe the actions and relationships between the extracted entities), numerical values, dates and times that place a story on the history timeline, the scale/resolution.
2) Audio->The first step is to convert audio data (a speech for example) into text. Then the methods used on texts are applied.
3) Video->video is audio data and pictures put together and synchronized. So, first the extraction is done by uniting the output of extraction from audio and the output from pictures extraction.
4) Pictures->Image analyzers and various AI technologies are used to extract data from pictures. We analyze the output of various such tools to further extract the sets of data that compose the KO (entities etc. described at 1)).
5) Formulas
6) For any other media that carries information/knowledge can be developed methods to extract data in order to create the corresponding KO

Conclusion. The output of this step is a set of extracted values that compose the KO. No matter the knowledge or the media format that carries it, our system is capable of using it in order to create the currency units.

associating a computer-processable object with the knowledge

At the moment when the identifying knowledge step is completed a new object is created and initialized (IPv6 address assigned, KO data stored in the corresponding structures etc.)

connecting/assigning a unique IPv6 number with the object (2a, 2b, 2c in FIG. 2)

The mechanism for assigning a unique IPv6 numbers (address) is the same all over our invention, no matter to which type of object it is assigned to.

So:

All objects are limited by design to be able request only once (using classic programming approaches for this), at the moment of creation, an IPv6 from an IPv6 Register Server. The server is storing in tables all the already assigned IPv6 addresses. The server is assigning addresses from one or more ranges that are reserved (bought) for the invention.

The IPv6 Register server together with the object being limited to only one request and together with the IPv6 protocol mechanisms guarantee the IPv6 number unicity across the system (invention).

Associating a count value to the object, the count being representative of credibility of the knowledge and/or of application scope of the knowledge

At this step we may be using for example the following formula: 100 units of information/knowledge=1 unit of money

Any formula that is found appropriate can be used. This does not affect the model/concept of the invention.

The calculus is done periodically by the Knowledge Object, and the value is stored in the Currency unit object.

Structure of the object (to describe this object we use the vocabulary of Objected Oriented Programming, OOP) data representing knowledge (1d in FIG. 2)

All this data is the output of the identifying/extracting system

Properties (the OOP meaning):
Reference to the media file (can be on a public/private access server or copied on a centralized infrastructure managed by the major accounting firm as described) where the KO data was extracted from
List of extracted entities
List of extracted causations
List of locations
List of properties (descriptors) of extracted entities
Scale (resolution)
Reference to the Currency unit object
IPv6 address (also with role of unique identifier)

Functionalities of the object (3 in FIG. 2)

Methods (the OOP meaning)
Request IPv6 from server. Runnable only once on creation (2 in FIG. 2))
All the classic methods for communicating over IPv6 protocol
Sending encrypted data/values about itself (4 in FIG. 2)
Methods to request updated values from the Currency unit object
Methods that periodically send reports about statuses or values

a currency unit representative of credibility of the knowledge and/or of application scope of the knowledge

The Reference to the Currency unit object

an IPv6 number, the IPv6 number being unique for the object (2a, 2b, 2c in FIG. 2)

Same mechanism as discussed above.

a count being representative of credibility of knowledge and/or of application scope of knowledge

an object being associated with the currency unit

Properties (the OOP meaning):
IPv6 address
Current (most recently calculated) value for “count”

Methods (the OOP meaning)
Methods to calculate the value of the “count” using formulas
Methods to respond to request from the KO about updated internal properties
Request IPv6 from server. Runnable only once on creation.

an IPv6 number, the IPv6 number being unique for the object (2a, 2b, 2c in FIG. 2)

Same mechanism as discussed above.

### Code Examples

All code examples are written in C #. Only the source code relevant to the invention is provided (no boiler plate code, no network communication detailed code etc).

Any method of encryption may be used for stored data, network communication etc. without affecting the architecture or the claims.

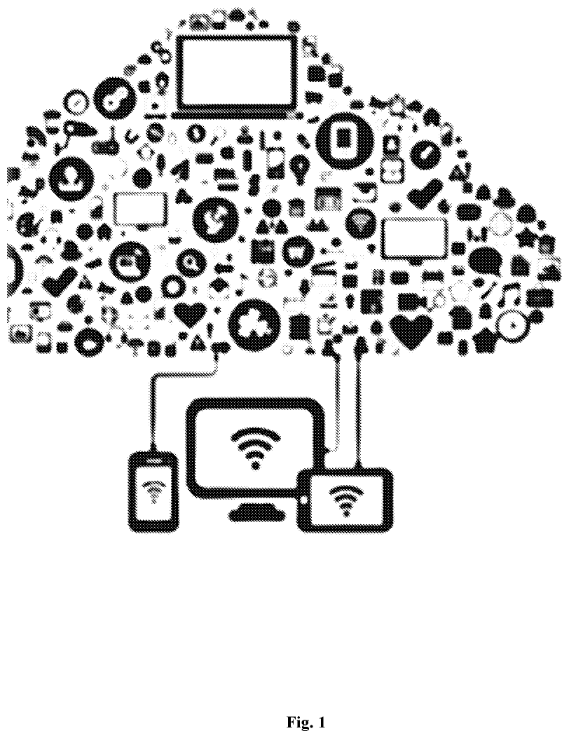

Code example no. 1—General design for IPv6 Assignment Authority (2b in FIG. 1)

class IPv6AssignmentAuthority

{

private string IPv6; //the IPv6 address of the Assignment Authority where all other

objects send requests to

private string IPv6RangeOfTheSystem; //reserved IPv6 ranges for the invention (or

bought as specified)

private string GetNextAvailableIPv6( )
{

string IPv6Addr=String.Empty;
//calls to methods that query the IPv6 Addresses Reservoir
//...
return IPv6Addr;

}
//Methods to query the IPv6 Reservoir
//Different implementations can be used depending of the type of reservoir.
//SQL Server DB, Oracle DB, Flat file even. This does not affect the architecture and

Claims of the invention

}

Code example no. 2—Logic of assigning IPv6 ID/address to objects (2c in FIG. 1)

//On creation of a new Knowledge Object the following steps are taken

KnowledgeObject newKO= new KnowledgeObject( );
newKO.GetIPv6Number( ); //see Code example no. 3

Code example no. 3—Creation of Empty encrypted Knowledge Object (3a in FIG. 1)

class KnowledgeObject

{

private File originalContent; //Can be any other reference type that locates the original

content

private List<Entity> Entities;
private List<Causation> Causations;
private List<Location> Locations;
private CurrencyUnit cu; //Object described
private double Scale; //Resolution
private double Unit;
private string IPv6=null; //also with role of unique identifier
//methods
private void GetIPv6Number( )
{

if(IPv6==null) //this guarantees that the Knowledge object is not able to ask for an

IPv6 number more than once

{

//network call to Assignement authority

}
//IPv6 = address assigned by the authority

}
//example method for populating the properties
private void populateIdentifiedEntities( )
{

string IdentifiedEntitiesSerializedCollection; //the collection of identified entities

can come in any format, this is just an example, a posibility.

| | |
|---|---|
| IdentifiedEntitiesSerializedCollection | = |

GetIdentifiedEntitiesFromExtractors(originalContent); //call to knowledge extraction
system

}

}

Code example no. 4—(3b in FIG. 1)

class CurrencyUnit

{

private string IPv6=null;
private float count; //current, most recently calculated value for ″count″
private float applicationScope;
private float credibility;
private float scale;
private float resolution;
//methods to calculate the value of the “count” using formulas as described
private void RecalculateCountUsingFormula1( )
{

//example used in the description of the invention, but can be any other formula

without affecting the architecture or the claims.

count = (100/KnowledgeObject.Unit)*applicationScope;

}
private void RecalculateCountUsingFormula2( )
{
}
private void GetIPv6Number( )
{

//same as in Code example no 3

}
//methods to respond to request from the KO about updated internal properties
protected void SayCount( )
{

//network communication logic to send the value over network

}

}

Code example no. 5—Empty money object (3c in FIG. 1)

class MoneyObject

{

private List<KnowledgeObject> KOs;
private string IPv6=null;
private List<Actions> History;
//methods
//example method for populating the KOs list
private void populateKOsList( )
{

KOs = GetContainedKOsFromQRMD(IPv6); //call to Quantum Relations Machine

central database (QRMD). Call can be remote or on the same machine

}
//method that implement a rule
private bool isBreakingRule1( )
{

bool result=false;
foreach(Action in History)
{

result = CheckAgainstRule1(Action); //CheckAgainst rule can be any custom

defined rule. For example: use=ilegal

if(result==true) return result;

}
return result;

}
//other methods for that implement full network communication capabilities

}

What is claimed is:

1. A computer-implemented method of creating currency units, comprising:
identifying, in a media file, a unit of knowledge, the unit of knowledge comprising data,
associating a computer-processable object with the knowledge, and
associating a unique IPv6 number with the computer-processable object,
wherein the computer-processable object comprises a reference to the media file in which the unit of knowledge was identified, a reference to the unit of knowledge, and a reference to a currency unit object.

2. The method of claim 1 further comprising:
associating a count value with the object, the count value being indicative of credibility of the knowledge or of application scope of the knowledge.

3. The method of claim 2, wherein the currency unit object comprises the count value.

4. A computer-processable object, comprising:
data representing knowledge;
a reference to a media file from which the data was retrieved;
a currency unit representative of credibility of the knowledge or of application scope of the knowledge; and
an IPv6 number, the IPv6 number being unique for the computer-processable object.

5. A currency unit comprising:
a count indicative of credibility of a unit of knowledge or of application scope of the unit of knowledge, the unit of knowledge being represented by data;
an object being associated with the currency unit, and
an IPv6 number, the IPv6 number being unique for the object.

6. The currency unit of claim 5, wherein the currency unit is sub-dividable.
